(19) United States
(12) Patent Application Publication
(10) Pub. No.: US 2019/0384143 A1
(43) Pub. Date: Dec. 19, 2019

(54) REMOTE-CONTROLLED PHOTO KIOSK

(71) Applicants: Stephen Lynch, Gainesville, GA (US); Teresa Leann Ramey, Gainesville, GA (US)

(72) Inventors: Stephen Lynch, Gainesville, GA (US); Teresa Leann Ramey, Gainesville, GA (US)

(21) Appl. No.: 16/444,116

(22) Filed: Jun. 18, 2019

Related U.S. Application Data
(60) Provisional application No. 62/686,130, filed on Jun. 18, 2018.

(51) Int. Cl. G03B 17/53; F16M 11/42; F16M 11/12; G03B 17/56; G06F 3/0488

(52) U.S. Cl. CPC G03B 17/53; F16M 11/42; G06F 3/0488; G03B 17/561; F16M 11/126

(57) ABSTRACT

Implementations of a remote-controlled photo kiosk are provided. In some implementations, the remote-controlled photo kiosk is self-propelled and configured to function as a photo booth and/or a data collection kiosk. In some implementations, the remote-controlled photo kiosk may be configured to provide branded photographs to guests which can be shared via social media. The remote-controlled photo kiosk comprises: a base that includes a powertrain; a support member that extends from the base; a kiosk head coupled to the support member; and a remote control configured to wirelessly operate the powertrain; wherein the power train is configured to facilitate self-propelled movement of the photo kiosk; and the kiosk head is configured to carry a tablet computer having a digital camera.

### CROSS REFERENCE TO RELATED APPLICATION

This application claims the benefit of U.S. Provisional Application Ser. No. 62/686,130, which was filed on Jun. 18, 2018, the entirety of which is incorporated herein by reference.

### TECHNICAL FIELD

This disclosure relates to implementations of a photo kiosk. In particular, the present disclosure is directed to implementations of a self-propelled photo kiosk that can be operated via a remote control.

### BACKGROUND

Photo booths and data collection kiosk are often used by brand ambassadors, event hosts, and product representatives, for marketing and data collection purposes. However, enticing guests at a public event to take a photo for social media, or to sign up for a mailing list, can be difficult.

An operator of a stationary photo booth, or data collection kiosk, must devise a way to attract guests thereto. But funneling guests to a fixed location can be difficult, particularly at tradeshows and festivals. Further, even if guests are attracted to, or inadvertently happen upon, the photo booth (or data collection kiosk) they are often reluctant to stop and use it.

Therefore, needs exist for a photobooth, or data collection kiosk, that is mobile and configured to entice guest interaction therewith.

Accordingly, it can be seen that needs exist for the remote-controlled photo kiosk disclosed herein. It is to the provision of remote-controlled photo kiosk that is configured to address these needs, and others, that the present invention is primarily directed.

### SUMMARY OF THE INVENTION

Implementations of a remote-controlled photo kiosk are provided. In some implementations, the remote-controlled photo kiosk is self-propelled and configured to function as a photo booth, a data collection kiosk, or a combination thereof.

The remote-controlled photo kiosk comprises: a base that includes a powertrain; a support member that extends from the base; a kiosk head coupled to the support member; and a remote control configured to wirelessly operate the powertrain; wherein the power train is configured to facilitate self-propelled movement of the photo kiosk; and the kiosk head is configured to carry a tablet computer having a digital camera.

In some implementations, the remote-controlled photo kiosk may further comprise a speaker that is wirelessly connected to a headset microphone worn by an operator. In this way, the operator may interact, or speak, directly with any guest(s) in close proximity to the remote-controlled photo kiosk.

### BRIEF DESCRIPTION OF THE DRAWINGS

FIGS. 1-3 illustrate an example remote-controlled photo kiosk in accordance with the principles of the present disclosure.

FIG. 4 illustrates the base of the remote-controlled photo kiosk shown in FIGS. 1-3, wherein the lid of the housing is open.

FIG. 5 illustrates a bottom view of the remote-controlled photo kiosk shown in FIGS. 1-3.

FIG. 6 illustrates an exploded view of the remote-controlled photo kiosk shown in FIGS. 1-3.

FIG. 7 illustrates a rear view of the kiosk head shown in FIGS. 1-3, wherein the back cover has been removed to expose the interior mounting mechanism for a tablet computer.

FIG. 8 illustrates a rear view of the kiosk head shown in FIG. 7, wherein the back cover is secured to the kiosk head in a first orientation.

FIG. 9 illustrates a rear view of the kiosk head shown in FIG. 7, wherein the back cover is secured to the kiosk head in a second orientation.

FIG. 10 illustrates another example remote-controlled photo kiosk in accordance with the principles of the present disclosure.

FIG. 11 illustrates the base of the remote-controlled photo kiosk shown in FIG. 10, wherein the lid of the housing is open.

FIG. 12 illustrates a rear view of the kiosk head shown in FIG. 10.

FIGS. 13 and 14 illustrate a rear view of the kiosk head shown in FIG. 11, wherein the back cover has been removed.

FIG. 15 illustrates a front view of the kiosk head shown in FIGS. 13 and 14, wherein the faceplate has been removed.

FIG. 16 illustrates a rear view of the faceplate shown in FIG. 15.

Like reference numerals refer to corresponding parts throughout the several views of the drawings.

### DETAILED DESCRIPTION

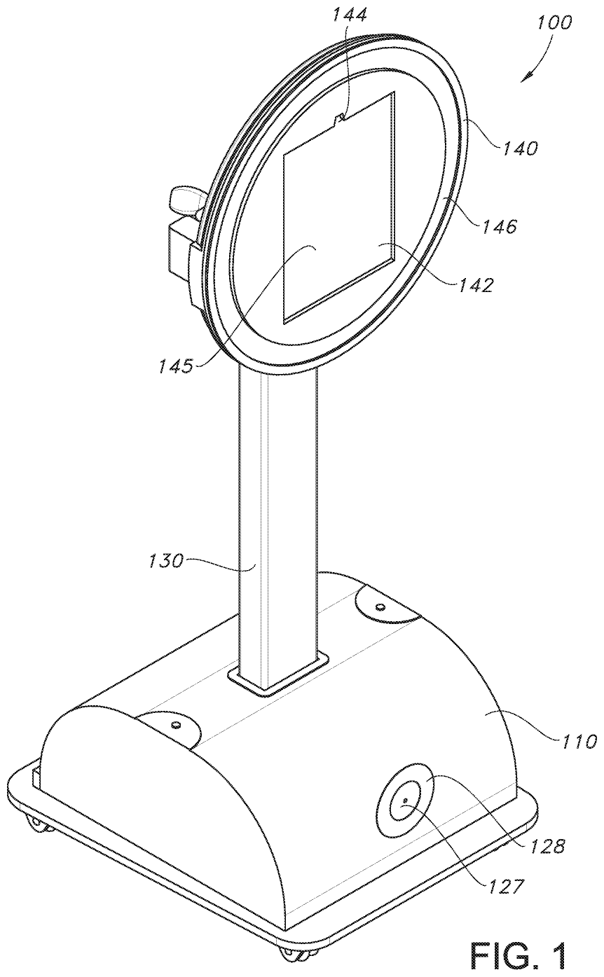

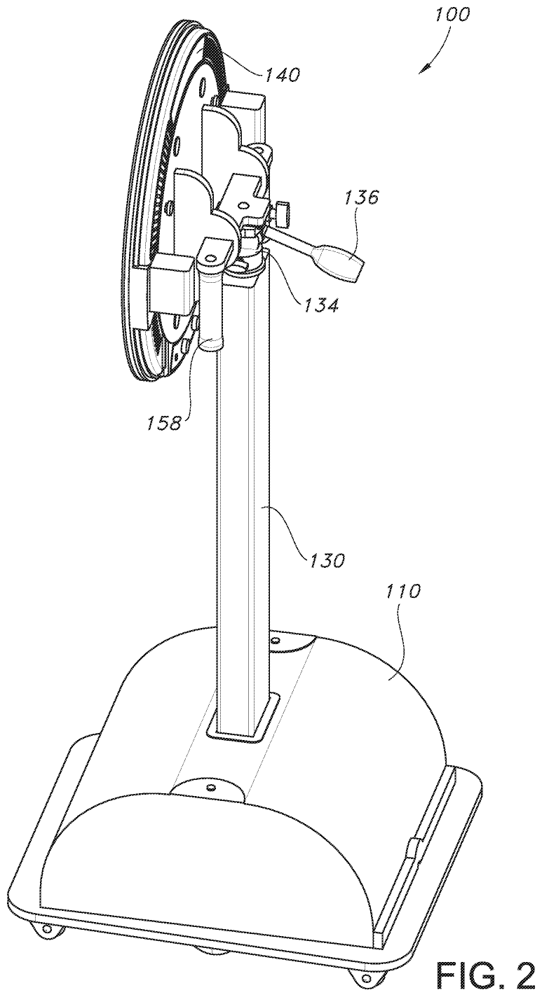

FIGS. 1-6 illustrate an example implementation of a remote-controlled photo kiosk 100 according to the principles of the present disclosure. In some implementations, the remote-controlled photo kiosk 100 may be self-propelled and configured to function as a photo booth, a data collection kiosk, or a combination thereof. In some implementations, the remote-controlled photo kiosk 100 may be configured to provide branded photographs to guests which can be shared via social media.

As shown in FIGS. 1-6, in some implementations, the remote-controlled photo kiosk 100 may comprise a base 110 that includes a powertrain, a support member 130 that extends from the base 110, a kiosk head 140 removably coupled to the support member 130, and a remote control 160. The power train of the base 110 is configured to facilitate self-propelled movement of the photo kiosk 100; and the kiosk head 140 is configured to carry a tablet computer 142 having a digital camera 144. In some implementations, the remote-controlled photo kiosk 100 may further comprise a speaker that is wirelessly connected to a headset microphone worn by an operator (not shown). In this way, the operator can interact, or speak, directly with any guest(s) in close proximity to the remote-controlled photo kiosk 100.

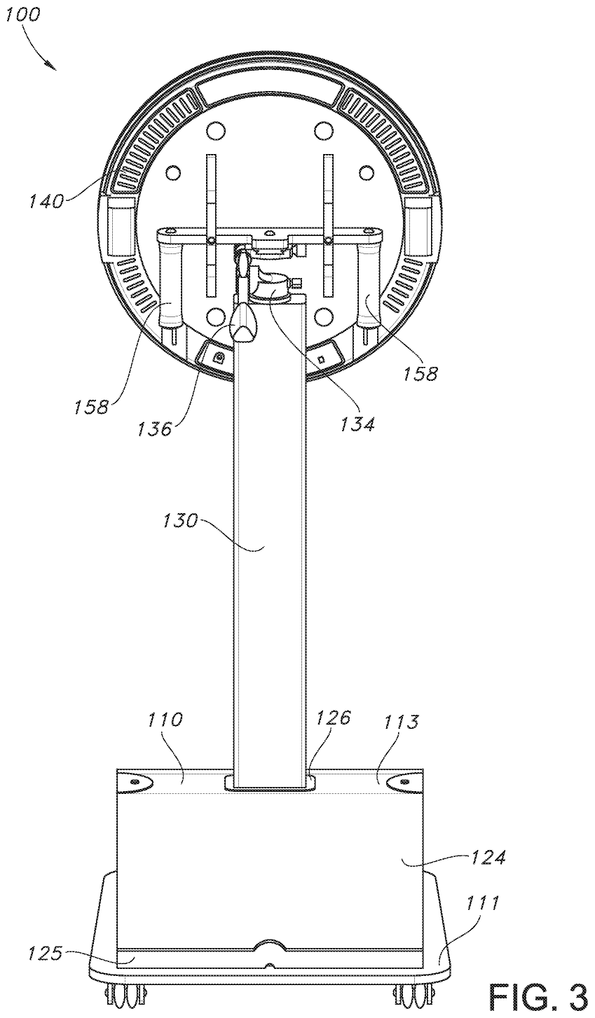

As shown in FIGS. 3-5, in some implementations, the base 110 of the remote-controlled photo kiosk 100 may comprise a platform 111 and a housing 113. In some implementations, the housing 113 may be secured to the platform 111 of the base 110 using one or more mechanical fasteners (e.g., screws). In some implementations, the platform 111 and the housing 113 of the base 110 may be a single unitary piece.

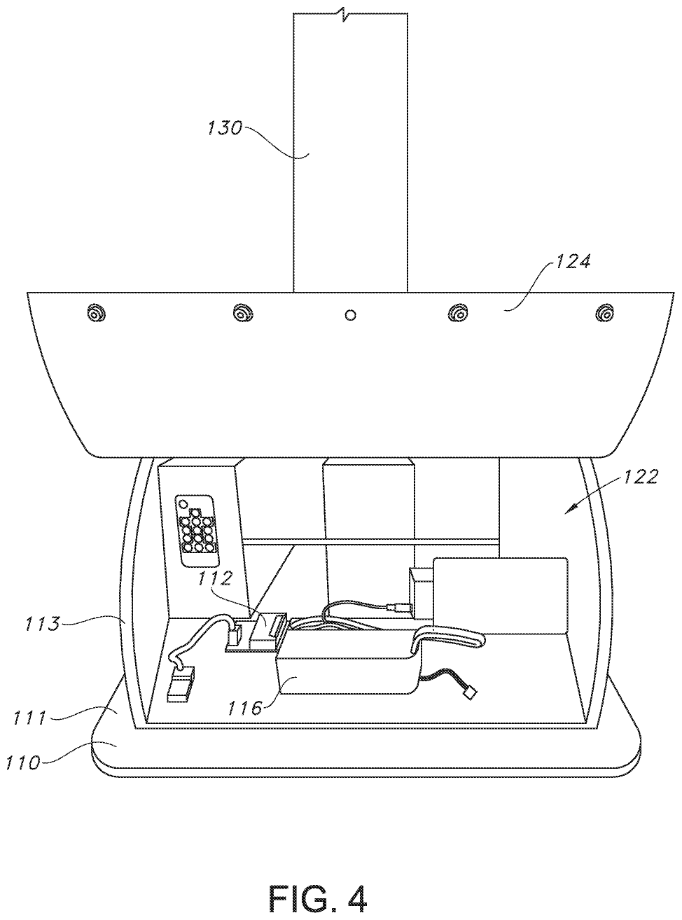

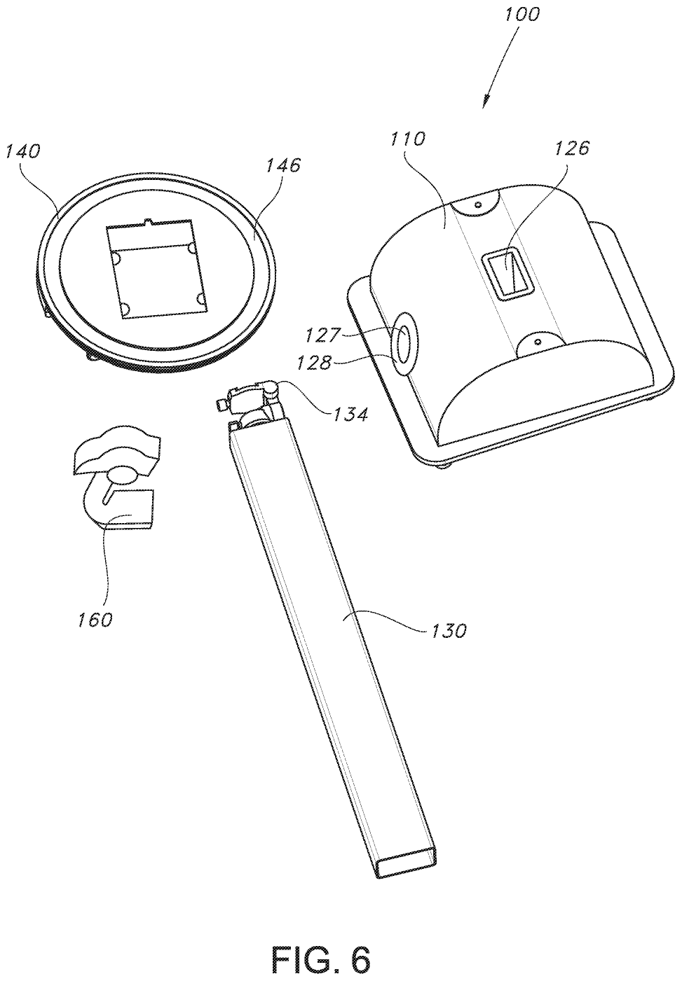

As shown in FIGS. 4 and 6, in some implementations, the housing 113 of the base 110 may comprise an interior compartment 122 accessible via a moveable lid 124 and an opening 126 in a top side thereof. In some implementations, the housing 113 of the base 110 may further comprise a reflective surface 127 having a light ring 128 positioned thereabout on a front side thereof (see, e.g., FIG. 1). In this way, guest attention may be drawn to the remote-controlled photo kiosk 100. In some implementations, the base 110 may not include the reflective surface 127 or the light ring 128.

As shown in FIG. 4, in some implementations, the lid 124 may be a flexible portion of the housing 113 that is configured to cover the entrance into the interior compartment 122. In some implementations, the lid 124 may be held closed by a mechanical fastener 125 (see, e.g., FIG. 3). In some implementations, the lid 124 may be a piece of material that is secured to the housing 113 by one or more hinges (not shown).

As shown in FIGS. 3 and 6, in some implementations, the opening 126 in the top side of the housing 113 may be configured to receive a first end of the support member 130 therein and to hold it in an upright position.

In some implementations, the light ring 128 on the base 110 may comprise one or more LEDs, or other suitable lighting technology.

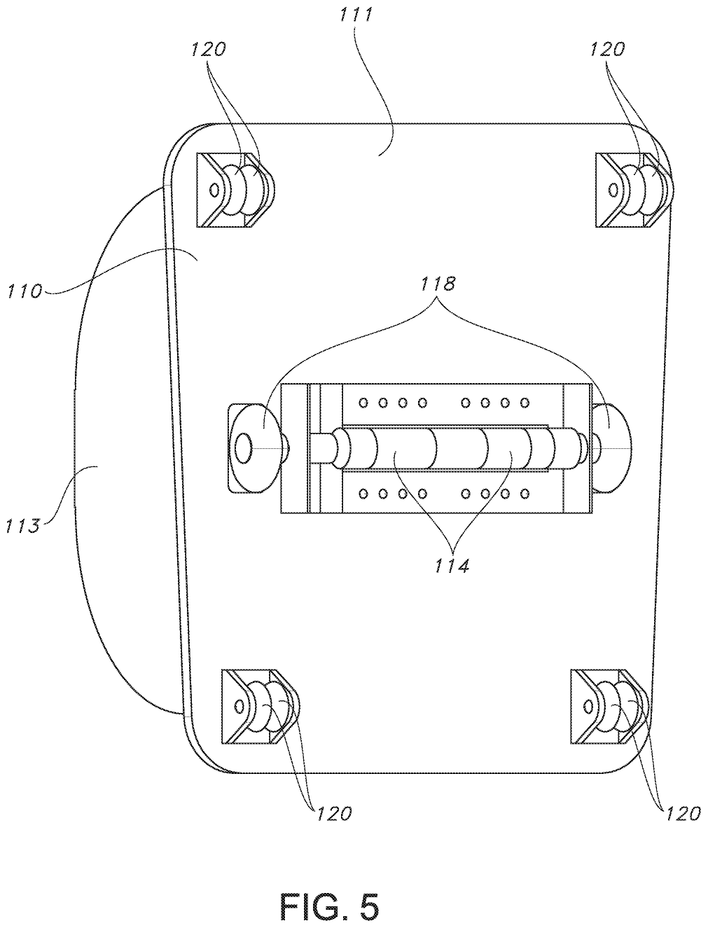

As shown in FIGS. 4 and 5, in some implementations, one or more portions of the powertrain may be positioned within the interior compartment 122 of the housing 113 and/or secured to the platform 111 of the base 110.

As shown in FIGS. 4 and 5, in some implementations, the powertrain of the remote-controlled photo kiosk 100 may comprise a motor controller 112, two electric motors 114 (e.g., high torque planetary gear motors), one or more batteries 116 (e.g., lithium polymer rechargeable batteries), and a differential steering system 118.

As shown in FIG. 4, in some implementations, the one or more batteries 116 stored within the interior compartment 122 of the housing 113 may be used to power electrical components (e.g., the powertrain and the light ring 128) of the remote-controlled photo kiosk 100. In some implementations, any battery, or combination of batteries, suitable for powering the electrical components of the remote-controlled photo kiosk 100 may be used.

As shown in FIG. 5, in some implementations, the differential steering system 118 may comprise centrally located drive wheels that are driven by the electric motor(s) 114. Using a differential steering system 118 allows the remote-controlled photo kiosk 100 to have a zero, or near zero, turning radius. In some implementations, the base 110 may also include one or more (e.g., eight) free turning wheels 120 on the underside thereof. In some implementations, the differential steering system 118 and the free turning wheels 120 may be secured to the underside of the platform 111 by one or more mechanical fasteners.

As shown in FIGS. 3 and 6, in some implementations, the support member 130 may comprise a first end configured to be received within the opening 126 in the topside of the base 110 and a second end that includes a mount 134 configured to removably couple with the kiosk head 140. In some implementations, the support member 130 may be a tube, pole, or other suitably configured support member.

In some implementations, the mount 134 of the support member 130 may be configured to rotate and tilt the kiosk head 140 coupled thereto. In some implementations, the mount 134 of the support member 130 may include a handle 136 that can be used to rotate and tilt a kiosk head 140 coupled thereto.

As shown in FIGS. 1-3 and 6, in some implementations, the kiosk head 140 is configured to removably couple with the mount 134 of the support member 130. In this way, when removed from the support member 130, the kiosk head 140 may be hand carried around an event and used by guest(s), or the operator, to collect data and/or take photographs. In some implementations, the kiosk head 140 may be configured to position a tablet computer 142 in a vertical orientation (see, e.g., FIG. 1) or a horizontal orientation. In this way, the digital camera 144 of the tablet computer 142 may be positioned to take portrait or landscape photographs.

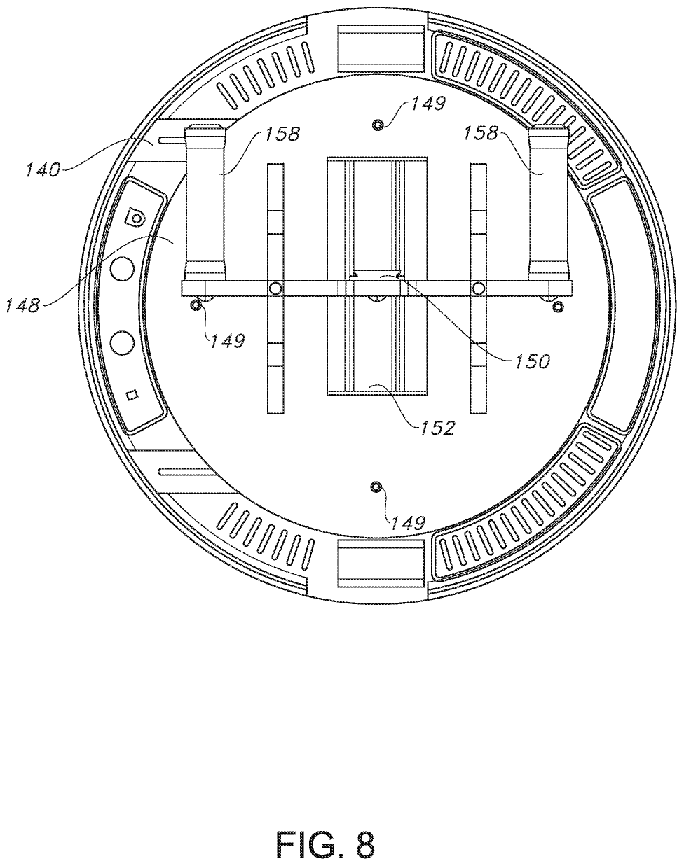

As shown in FIGS. 1 and 7-9, in some implementations, the kiosk head 140 may include a light ring 146 on a front side thereof, an interior mounting mechanism for the tablet computer 142, and a removable back cover 148 that includes an adapter 150. In some implementations, the kiosk head 140 may also include a battery pack 152 that is mounted to the back cover 148 thereof (see, e.g., FIG. 8).

In some implementations, the light ring 146 of the kiosk head 140 may be configured to illuminate a subject (e.g., one or more guests) and thereby aid the digital camera 144 of the tablet computer 142. In some implementations, the light ring 146 may be an annular arrangement of LEDs, or other lighting technology, positioned adjacent an exterior edge kiosk head's 140 front side. In some implementations the light ring 146 may be any suitable arrangement of LEDs, or other lighting technology, positioned on the front side of the kiosk head 140 capable of assisting the digital camera 144 with capturing digital photographs. In some implementations, the light ring 146 may be a dual color, temperature adjustable LED light ring. In some implementations, the light ring 146 may be any light ring suitable for use as part of a kiosk head 140.

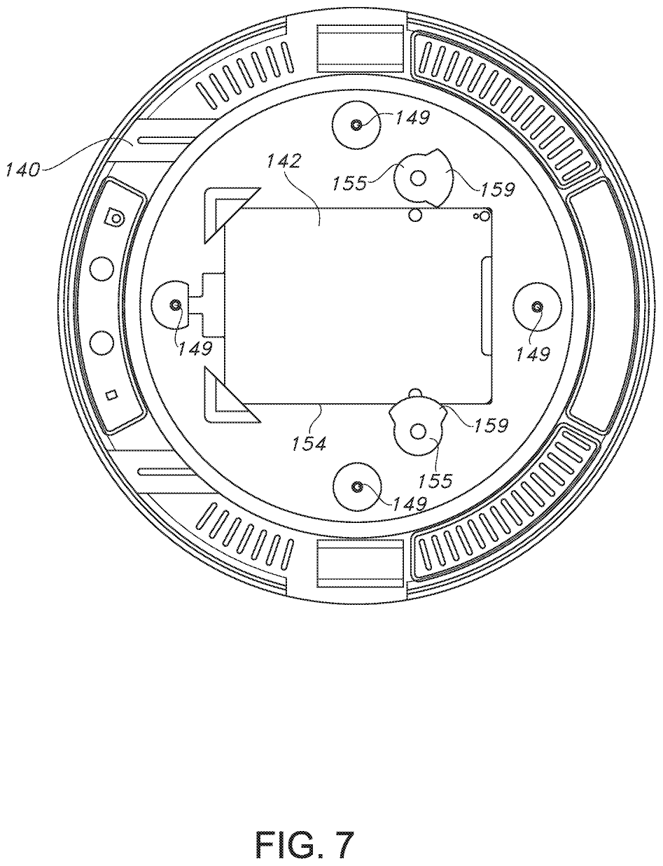

As shown in FIG. 7, in some implementations, the kiosk head 140 may include a cutout 154 therein that is configured to receive the tablet computer 142. In some implementations, the cutout 154 in the kiosk head 140 may be configured to capture two corners of a tablet computer 142 positioned therein. In some implementations, the mounting mechanism may comprise two rotatable fastenings 155 configured to secure the tablet computer 142 within the cutout 154 of the kiosk head 140. In this way, as shown in FIG. 1, the touchscreen display 145 may be positioned for use and the digital camera 144 positioned to capture digital photographs. In some implementations, each rotatable fastening 155 may include a flange portion 159 configured to be removably positioned behind the tablet computer 142 while it's positioned within the cutout 154 of the kiosk head 140. In this way, the rotatable fastenings 155 may be used to hold the tablet computer 142 within the cutout 154.

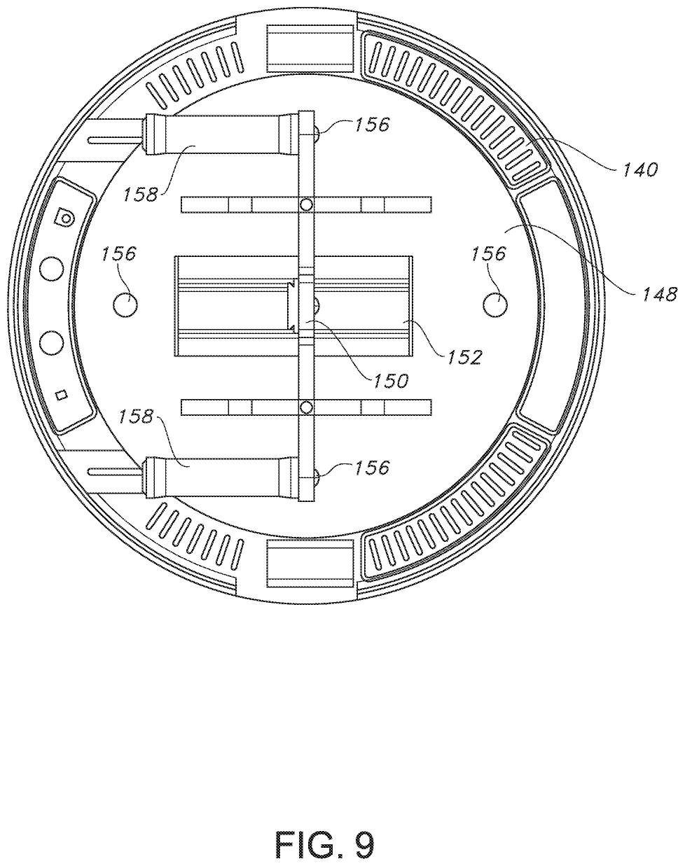

As shown in FIG. 9, in some implementations, threaded fasteners 156 (e.g., four) may be used to secure the back cover 148 to the kiosk head 140. In some implementations, each threaded fastener 156 may extend through an opening in the back cover 148 and threadedly engage with an aligned receptacle 149 in the kiosk head 140 (see, e.g., FIGS. 7 and 8).

As shown in FIGS. 8 and 9, in some implementations, the back cover 148, and thereby the adapter 150 attached thereto, may be secured to a back side of the kiosk head 140 in at least two different orientations. In this way, when the adapter 150 of the kiosk head 140 is coupled to the mount 134 of the support member 130, the tablet computer 142 may be positioned in a horizontal orientation (see, e.g., FIG. 8) or a vertical orientation (see, e.g., FIG. 9).

As shown in FIGS. 8 and 9, in some implementations, the back cover 148 of the kiosk head 140 may include two handles 158. Each handle 158 is configured to be held by the operator, or a guest, and used to carry the kiosk head 140 around an event. Also, the handles 158 may be used to support the kiosk head 140 when coupling, or decoupling, the adapter 150 thereof to the mount 134 of the support member 130.

In some implementations, the battery pack 152 secured to the kiosk head 140 may be one or more lithium polymer rechargeable battery cells. In some implementations, the battery pack 152 may be used to power the electrical components (e.g., the tablet computer 142 and/or the light ring 146) of the kiosk head 140. In some implementations, the battery pack 152 may be configured to augment a native power source of the tablet computer 142 and/or the light ring 146. In some implementations, any battery, or combination of batteries, suitable for powering the electrical components of the kiosk head 100 may be used. In some implementations, the kiosk head 140 may not include an external battery pack 152.

In some implementations, the tablet computer 142 includes a digital camera 144, an LCD touchscreen display 145, a mobile operating system, a rechargeable battery, and a memory (e.g., nonvolatile memory). In some implementations, the tablet computer 142 may be conductively connected to the battery pack 152 that is mounted on the back cover 148 of the kiosk head 140. In some implementations, the tablet computer 142 may be an iPad® that was designed, developed, and marketed by Apple Inc. In some implementations, the tablet computer 142 may be any other tablet computer having a digital camera, that is otherwise suitable for use as part of a remote-controlled photo kiosk 100.

In some implementations, the tablet computer 142 may include one or more mobile applications, stored in the memory thereof, that individually, or collectively, are configured to capture digital images (e.g., digital photographs and/or video) using the digital camera 144. In some implementations, the mobile application(s) may be configured to provide a user interface on the touchscreen display 145 of the tablet computer 142. In some implementations, at the user interface, a user (e.g., the operator or a guest) can review the captured content (e.g., one or more digital photographs) and select to retake or share the content. In some implementations, at the user interface, a user can provide at least one e-mail address, social media contact(s), or other contact information, to facilitate the receipt and sharing of the captured content. In this way, the remote-controlled photo kiosk 100 may also be used as a data collection kiosk. In some implementations, the captured content may not be tied to data collection methods. In some implementations, the mobile application(s) of the tablet computer 142 may be configured to brand the digital content (e.g., place a logo or message on the digital photo) prior to it being electronically transmitted to a guest via e-mail, social media, etc.

In some implementations, the remote control 160 may be configured to wirelessly operate the powertrain of the remote-controlled photo kiosk 100. In this way, the operator may drive the remote-controlled photo kiosk 100 throughout a venue to entice guest (e.g., customers) to interact with it. In some implementations, the remote control 160 (e.g., a 2.4 GHz spread spectrum remote control RC) may be used to remotely operate the differential steering system 118 of the remote-controlled photo kiosk 100.

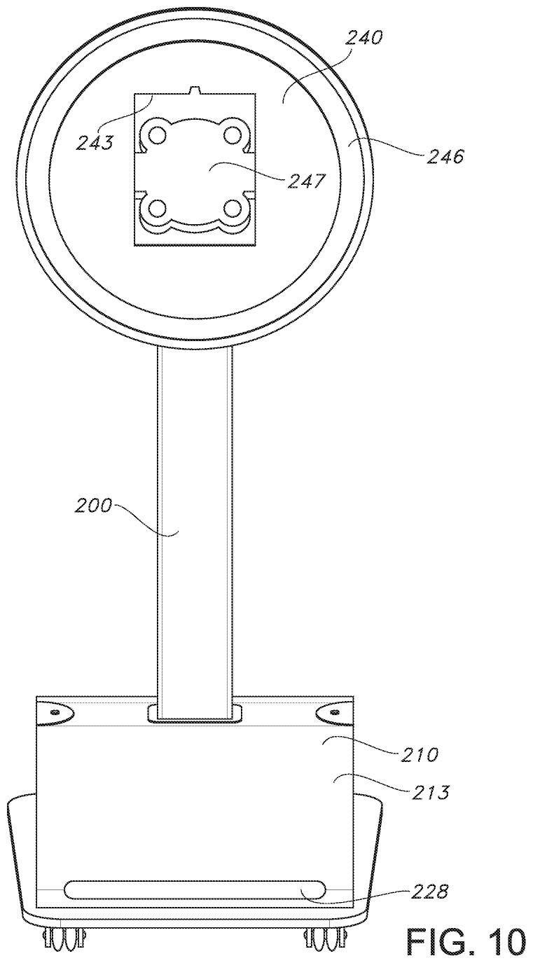

FIG. 10 illustrates another example implementation of a remote-controlled photo kiosk 200 in accordance with the present disclosure. Except as noted below, the remote-controlled photo kiosk 200 is similar to the remote-controlled photo kiosk 100 discussed above.

As shown in FIG. 10, in some implementations, the light ring 128 on the base 210 of a remote-controlled photo kiosk 200 may be replaced with a light bar 228. In some implementations, the light bar 228 may comprise one or more LEDs, or other suitable lighting technology.

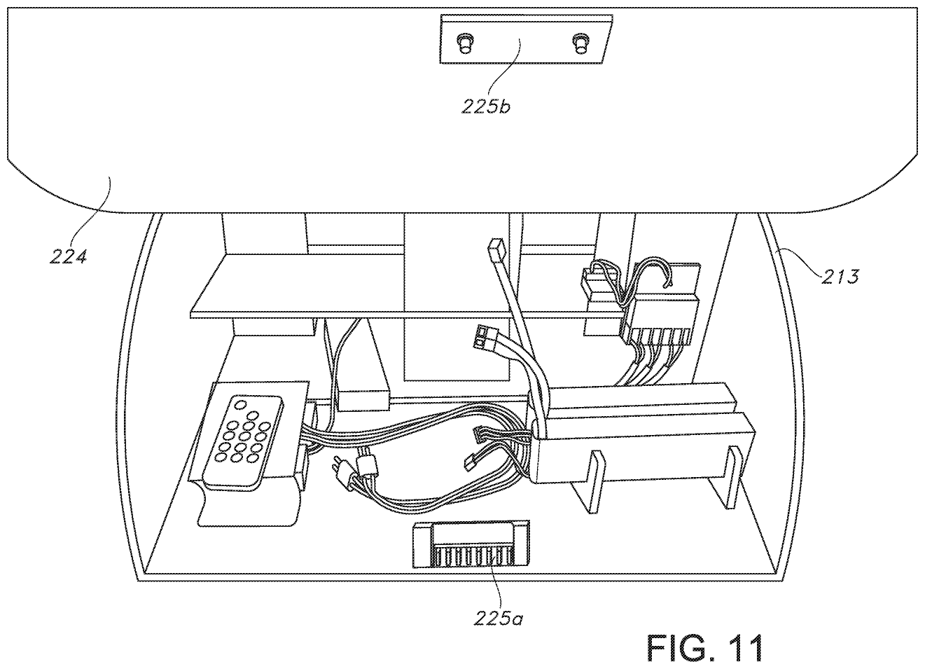

As shown in FIG. 11, in some implementations, the lid 224 of the housing 213 may be held closed by a magnetic fastening latch 225. In some implementations, the magnetic fastening latch 225 includes a magnetic latch 225a and a cooperative strike plate 225b.

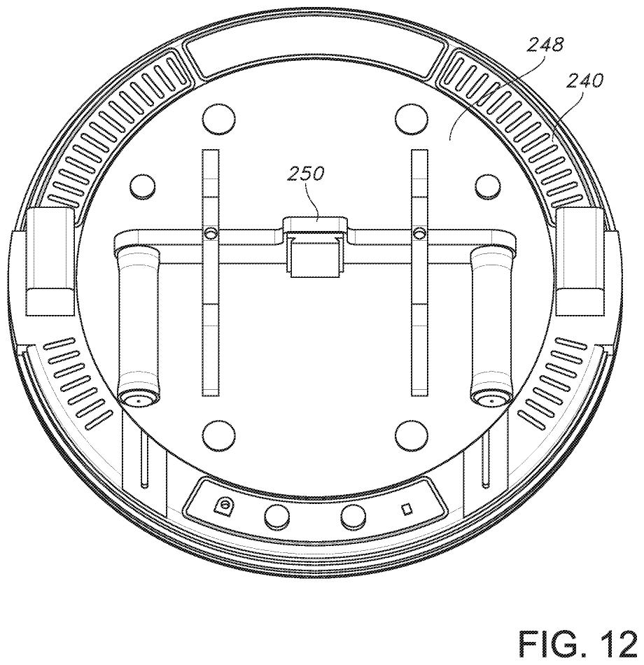

As shown in FIGS. 12-16, in some implementations, the kiosk head 240 may comprise a removable back cover 248 that includes an adapter 250, a removable brace 247 configured to secure a tablet computer within a receptacle 254 in the kiosk head 240, and a removable faceplate 241.

As shown in FIG. 12, in some implementations, the removable back cover 248 and adapter 250 of the remote-controlled photo kiosk 200 are the same as, or substantially similar to, the removable back cover 148 and adapter 150 discussed above in connection with the remote-controlled photo kiosk 100.

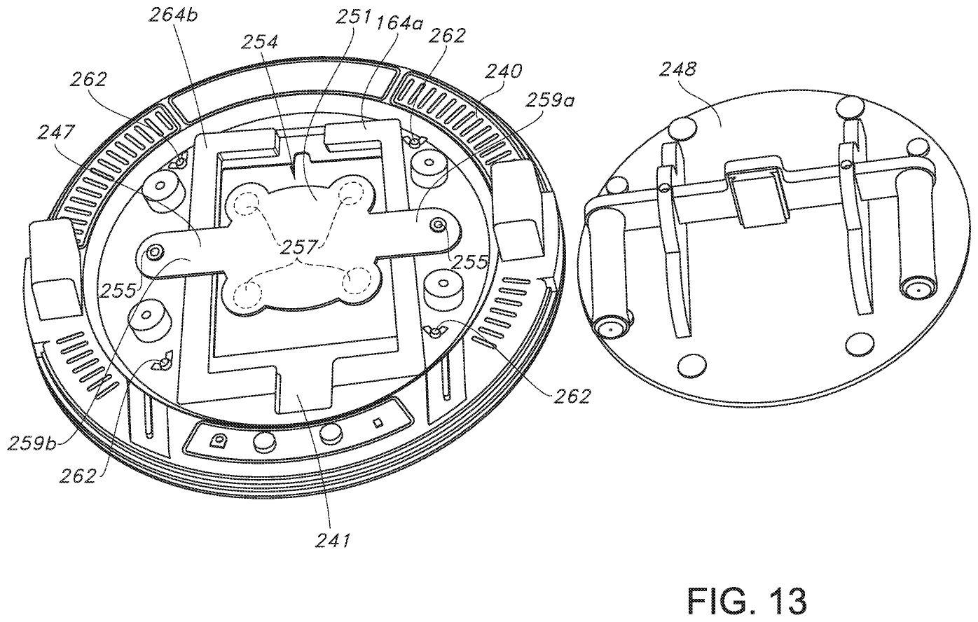

As shown in FIG. 13, in some implementations, the removable brace 247 may be configured to position a tablet computer within the receptacle 254 of the kiosk head 240. In some implementation, the removable brace 247 may comprise a body portion 251 and two arms 259a, 259b. The body portion 251 of the removable brace 247 is configured to press against a backside of a tablet computer (not shown) positioned within the receptacle 254 of the kiosk head 240 when the first arm 259a and the second arm 259b thereof are each secured to the kiosk head 240 by a mechanical fastener 255. In some implementations, the body portion 251 of the removable brace 247 may include one or more cushioning pads 257 (e.g., felt pads) on the side resting against a tablet computer positioned within the receptacle 254 of the kiosk head 240. In this way, the cushioning pads 257 may protect the case of the tablet computer from being scratched by the brace 247.

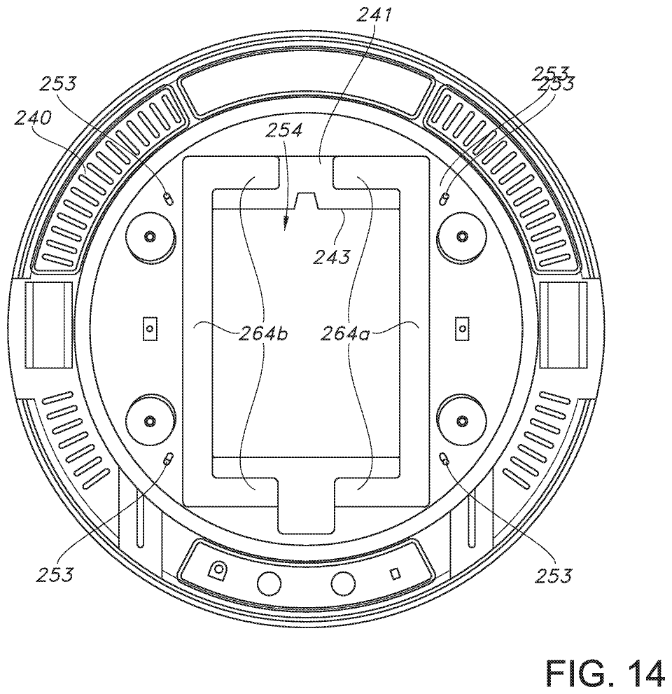

As shown in FIGS. 13 and 14, the tablet receptacle 254 of the kiosk head 240 may be configured to accommodate tablet computers of differing dimensions, and to rely on the removable brace 247 to secure a tablet computer in position therein. In some implementations, the receptacle 254 may include two removable spacers 264a, 264b configured to frame a tablet computer therein, and to position the tablet computer relative to a cutout 243 in the faceplate 241 of the kiosk head 240. In this way, a remote-controlled photo kiosk 200 is not limited to use with a single brand/model of tablet computer and the tablet computer is positioned so that a user is able to make contact with the touchscreen display thereof. In some implementations, each spacer 264a, 264b may be substantially “C” shaped in plain view (see, e.g., FIG. 14). In some implementations, a combination of spacers 264a, 264b may be any shape suitable for positioning a tablet computer therebetween, in the kiosk head 240 of a remote-controlled photo kiosk 200. In some implementations, each spacer 264a, 264b may be secured in position using an adhesive tape (e.g., vinyl tape), a liquid adhesive, or by any other suitable fastener known to one of ordinary skill in the art.

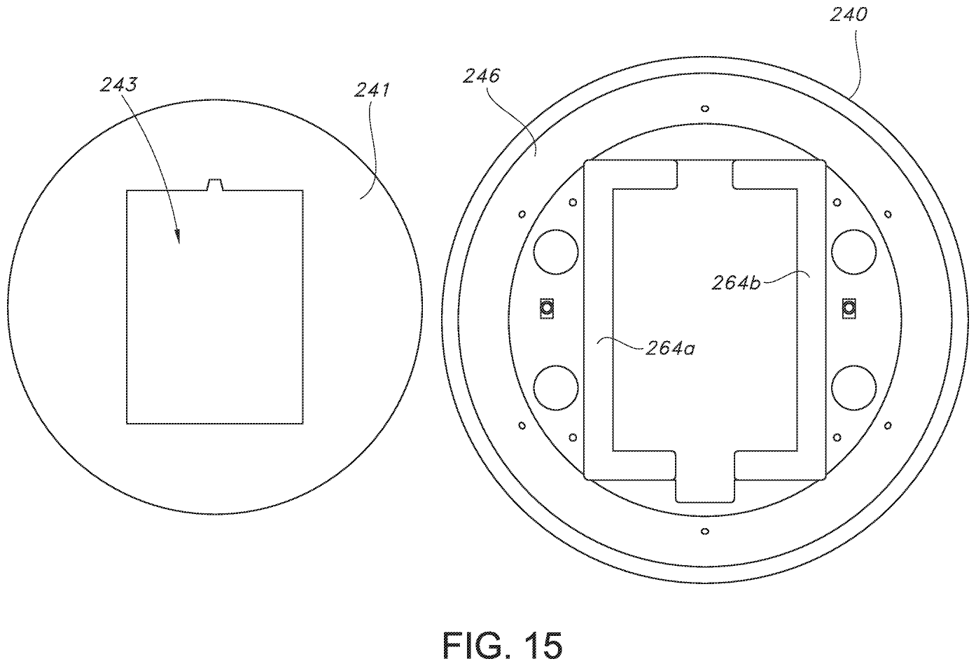

As shown in FIG. 15, in some implementations, the removable faceplate 241 of the kiosk head 240 may include a reflective surface on a front side thereof. In some implementations, the removable faceplate 241 may be configured so that the diameter thereof does not fully obscure the light ring 246 of the kiosk head 246. In some implementations, the cutout 243 in the removable faceplate 241 is configured to not obstruct the touchscreen display or the digital camera of the tablet computer positioned within the kiosk head 240.

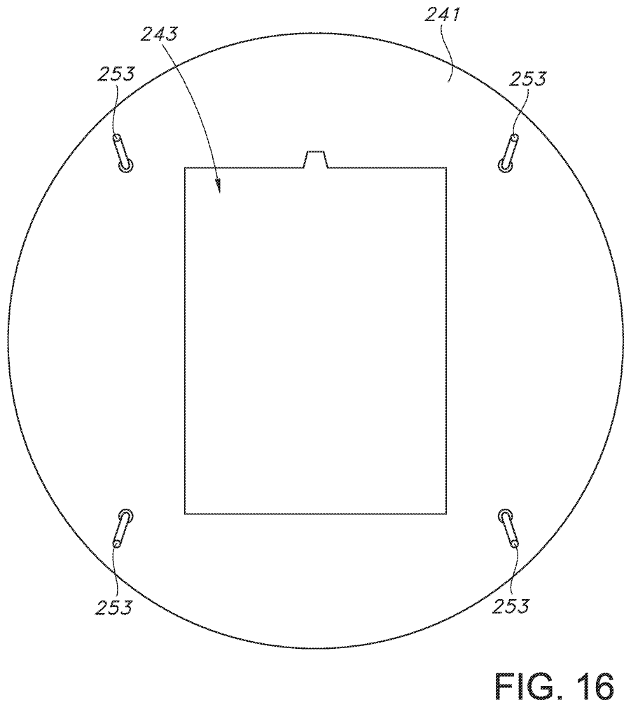

As shown in FIG. 16, in some implementations, the removable faceplate 241 may comprise one or more threaded studs 253 (e.g., four) that extend from a backside thereof. Each of the threaded studs 253 is configured to extend through an opening in the kiosk head 240 when the faceplate 241 is positioned thereon (see, e.g., FIG. 14). In some implementations, a wingnut 262, or other suitable fastener, may be secured to each threaded stud 253 and thereby used to secure the removable faceplate 241 in position (see, e.g., FIG. 13). In this way, there are no visible fasteners on the front side of the kiosk head 240 and a removable faceplate 241 having a cutout 243 configured for use with the selected tablet computer can be mounted on the kiosk head 240.

The following is an example of how one or more implementations of the remote-controlled photo kiosk 100, 200 could be used. Initially, an operator would identify potential guests with whom they would like to interact. Interact, as used herein, means to provide an opportunity to take a digital photo using the photo kiosk 100, 200 and, in some implementations, to introduce a product, service, and/or message. Then, the remote-controlled photo kiosk 100, 200 would be driven to the location of the targeted guest(s) so that the lights and/or form factor can entice them to investigate the purpose of the photo kiosk 100, 200. Next, the operator may interact with the targeted guest(s) by offering to take a digital photo, which can be transferred to a guest as outlined above. In some implementations, the photo opportunity may, or may not, be tied to one or more data collection methods (e.g., e-mail collection, etc.).

In some implementations, the remote-controlled photo kiosk 100, 200 may be configured to carry one or more signs, a TV monitor, or other electronic devices. In some implementations the remote-controlled photo kiosk 100, 200 may be used to distribute coupons in a retail establishment, to conduct political polling, or to provide a mobile message anywhere a group, or line, of people are present.

Although not shown in the drawings, it will be understood that suitable wiring connects the electrical components of the remote-controlled photo kiosk 100, 200 disclosed herein.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A photo kiosk comprising:
a base that includes a powertrain;
a support member that extends from the base;
a kiosk head coupled to the support member; and
a remote control configured to wirelessly operate the powertrain;
wherein the power train is configured to facilitate self-propelled movement of the photo kiosk; and the kiosk head is configured to carry a tablet computer having a digital camera.

2. The photo kiosk of claim 1, further comprising a speaker that is wirelessly connected to a headset microphone worn by an operator of the photo kiosk.

3. The photo kiosk of claim 1, wherein the base also includes a reflective surface that has a light ring positioned thereabout, the light ring is an annular arrangement of light sources, both the reflective surface and the light ring are positioned on a front side of the base.

4. The photo kiosk of claim 1, wherein the base also includes a light bar positioned on a front side thereof, the light bar is a linear arrangement of light sources.

5. The photo kiosk of claim 1, wherein the powertrain includes a differential steering system.

6. The photo kiosk of claim 1, wherein the kiosk head comprises a light ring that is configured to illuminate a subject, the light ring is an annular arrangement of light sources positioned on a front side of the kiosk head.

7. The photo kiosk of claim 1, wherein the kiosk head includes a receptacle configured to receive a tablet computer therein and a removable brace configured to secure the tablet computer within the receptacle.

8. The photo kiosk of claim 7, wherein the kiosk head includes a faceplate having a cutout therein and removable spacers, the spacers are configured to position the tablet computer within the receptacle so that a touchscreen of the tablet computer is accessible through the cutout in the faceplate.

9. The photo kiosk of claim 8, wherein the faceplate is removably secured to the kiosk head and includes a reflective surface on a front side thereof.

10. A photo kiosk comprising:
a base that includes a powertrain;
a vertical support member that extends from the base;
a kiosk head removably coupled to the vertical support member; and
a remote control configured to wirelessly operate the powertrain;
wherein the power train is configured to facilitate self-propelled movement of the photo kiosk; the kiosk head is configured to carry a tablet computer having a digital camera; and the kiosk head can be removed from the vertical support member and used to capture digital images.

11. The photo kiosk of claim 10, further comprising a speaker that is wirelessly connected to a headset microphone worn by an operator of the photo kiosk.

12. The photo kiosk of claim 10, wherein the base also includes a reflective surface that has a light ring positioned thereabout, the light ring is an annular arrangement of light sources, both the reflective surface and the light ring are positioned on a front side of the base.

13. The photo kiosk of claim 10, wherein the base also includes a light bar positioned on a front side thereof, the light bar is a linear arrangement of light sources.

14. The photo kiosk of claim 10, wherein the powertrain includes a differential steering system.

15. The photo kiosk of claim 10, wherein the kiosk head comprises a light ring that is configured to illuminate a subject, the light ring is an annular arrangement of light sources positioned on a front side of the kiosk head.

16. The photo kiosk of claim 10, wherein the kiosk head includes a receptacle configured to receive a tablet computer therein and a removable brace configured to secure the tablet computer within the receptacle.

17. The photo kiosk of claim 16, wherein the kiosk head includes a faceplate having a cutout therein and removable spacers, the spacers are configured to position the tablet computer within the receptacle so that a touchscreen of the tablet computer is accessible through the cutout in the faceplate.

18. The photo kiosk of claim 17, wherein the faceplate is removably secured to the kiosk head and includes a reflective surface on a front side thereof.

19. The photo kiosk of claim 10, wherein the kiosk head includes at least one handle that can be used to carry the kiosk head while it is detached from the vertical support member.
